(19) United States
(12) Patent Application Publication
(10) Pub. No.: US 2026/0205266 A1
(43) Pub. Date: Jul. 16, 2026

(54) SECURE TWO-WAY AUTHENTICATION METHOD AND SYSTEM

(71) Applicant: SHENZHEN TOPWISE COMMUNICATION CO.,LTD., Shenzhen (CN)

(72) Inventors: SHAOBIAN WANG, Shenzhen (CN); XIAOLING WANG, Shenzhen (CN); WEIDE ZENG, Shenzhen (CN)

(21) Appl. No.: 19/307,812

(22) Filed: Aug. 22, 2025

(30) Foreign Application Priority Data
Jan. 13, 2025 (CN) 202510045675.6

(51) Int. Cl. H04L 9/08; H04L 9/32; H04L 65/1108

(52) U.S. Cl. CPC H04L 9/0819; H04L 9/0869; H04L 9/3213; H04L 65/1108

(57) ABSTRACT

A secure two-way authentication method and system are provided. In this method, a web front-end sends a request to control an android terminal to an SRS server. When receiving the request, the android terminal generates a key pair and encrypts a public key before sending it to the SRS server. After receiving the request again and a user agrees, an SP security chip generates a 32-bit random number as a control token and sends it to the SRS server. The server saves this random number and waits for an opcode. The web front-end obtains screen recording information and generates the opcode to send to the SRS server, the server encrypts it, and sends it together with the opcode to the android terminal. The android terminal uses the private key to decrypt data, verifies whether the random number is matched, and executes the opcode.

### CROSS-REFERENCE TO RELATED APPLICATIONS

This application claims priority to Chinese Patent Application No. 202510045675.6, filed on January 13, 2025, which is hereby incorporated by reference in its entirety.

### TECHNICAL FIELD

The present disclosure relates to the field of communications technologies, and in particular, to a secure two-way authentication method and system.

### BACKGROUND

The remote-control solution refers to an android device obtaining screen information and transmitting it in real time to a Simple Realtime Server, (SRS) server through a Web Real-Time Communications, (WebRTC) video data stream. A web front-end displays an android terminal screen in real time through this data stream, generates a corresponding command opcode through an operation of the web front-end, and transmits it to the android device terminal through a MQTT protocol. The android terminal parses the plaintext opcode and performs movement and click an operation according to the command opcode. Because the android terminal subscribes to related topics through the MQTT protocol, when the topic is known, others can send relevant command opcodes through the topic, which may pose a security risk.

Therefore, the opcode for remote control of the android device in existing technology is easily obtained by third parties and tampered with, which may not meet the requirements of secure devices.

This application provides a secure two-way authentication method and system to solve a problem of control instructions being intercepted and tampered with by third parties.

On the one hand, the present application provides a secure two-way authentication method, including:

sending a control request to an SRS server through a Message Queuing Telemetry Transport, (MQTT) protocol, by a web front-end, requesting an establishment of control over an android terminal; when the android terminal receives the control request for a first time, automatically generating an Rivest-Shamir-Adleman, (RSA)3 public-private key pair, by a Security Chip, (SP) security chip of the android terminal, encrypting the RSA3 public key using the RSA2 private key, and sending it to the SRS server; where the android terminal is provided with the SP security chip, RSA2 public key, and RSA2 private key; decrypting the RSA3 public key data encrypted by the android terminal using the RSA2 private key through the RSA2 public key, by the SRS server, obtaining the RSA3 public key, and waiting for a user to confirm a connection request; the SRS server includes a built-in RSA1 private key and RSA1 public key; after the user confirming the request, generating a 32-bit random number, by the SP security chip of the android terminal, encrypting the 32-bit random number using the RSA1 public key of the SRS server, and sending it to the SRS server; decrypting and saving the 32-bit random number as a verification token using the RSA1 private key, by the SRS server; obtaining a screen recording permission, by the android terminal, and transmitting a screen recording interface in real-time to the web front-end of the SRS server through WebRTC technology; generating an operation instruction code, by the web front-end, and sending it to the SRS server; filling in the 32-bit random number, by the SRS server, and encrypting the operation instruction code and the 32-bit random number using the RSA3 public key; sending encrypted data packet to the android terminal; decrypting received data packet using the RSA3 private key in the SP security chip, by the android terminal, and verifying whether the 32-bit random number is correct; when the verification passes, executing an operation in the operation instruction code, by the android terminal.

On the other hand, the present application provides a secure two-way authentication system, including:

a web front-end, an SRS server, and an android terminal, where the android terminal is provided with an SP security chip, an RSA2 public key, and a RSA2 private key; the SRS server includes a built-in RSA1 private key and a RSA1 public key;

the web front-end sends a control request to the SRS server through a MQTT protocol, requests an establishment of control over the android terminal;

when the android terminal receives the control request for a first time, the SP security chip automatically generates an RSA3 public-private key pair, encrypts the RSA3 public key using the RSA2 private key, and sends it to the SRS server;

the SRS server decrypts the RSA3 public key data encrypted by the android terminal using the RSA2 private key through the RSA2 public key, obtains the RSA3 public key, and waits for a user to confirm a connection request;

after the user confirms the request, the SP security chip of the Android terminal generates a 32-bit random number, encrypts the 32-bit random number using the RSA1 public key of the SRS server, and sends it to the SRS server;

the SRS server decrypts and saves the 32-bit random number as a verification token using the RSA1 private key;

the android terminal obtains a screen recording permission and transmits a screen recording interface in real-time to the web front-end of SRS server through WebRTC technology;

the web front-end generates an operation instruction code and sends it to the SRS server; the SRS server fills in the 32-bit random number and encrypts the operation instruction code and the 32-bit random number using the RSA3 public key; encrypted data packet is then sent to the android terminal;

the android terminal decrypts received data packet using the RSA3 private key in the SP security chip, and verifies whether the 32-bit random number is correct; when the verification passes, the android terminal executes an operation in the operation instruction code.

The secure two-way authentication method and system provided in this application achieves the protection of data transmission integrity and security by using two sets of built-in RSA public and private keys and one set of RSA public and private keys generated by the SP security chip for encryption and decryption.

At the first connection, this method uses two sets of built-in RSA public and private keys to encrypt and transmit the RSA public key generated by the SP security chip. Subsequently, the web front-end initiates the control request, and the android terminal agrees to the MQTT control request upon receiving it. The SP security chip generates the 32-bit random number and sends it as a part of a request result to the backend, and this 32-bit random number is saved in the backend as the token for this control.

At the same time, the web front-end obtains the screen recording information of the android terminal through WebRTC technology and displays it on the page. The user performs operations on the page, generates the corresponding opcode, and then the opcode is sent to the backend. After receiving the opcode, the backend fills in the previously saved 32-bit random number, encrypts the opcode and random number using the RSA public key of the SP security chip, and then sends the encrypted data to the android terminal.

After receiving encrypted data, the android terminal decrypts it using the private key in the SP security chip and verifies whether the 32-bit random number in the decrypted data matches the previously sent one. Only when the random number is matched, the android terminal executes the corresponding opcode.

In this way, the method provided by the present disclosure ensures data transmission security during a remote desktop control of the android device, thereby effectively preventing a risk of data theft or tampering.

### BRIEF DESCRIPTION OF DRAWINGS

The accompanying drawings are incorporated into the specification and form a part of the specification, illustrating embodiments in accordance with the present application and used together with the specification to explain the principles of the present application.

FIG. 1 is a flowchart of a WEB terminal remotely controlling a terminal through an MQTT server provided in an embodiment of the present disclosure.

FIG. 2 is a first screen recording interface diagram of the web terminal provided in an embodiment of the present disclosure.

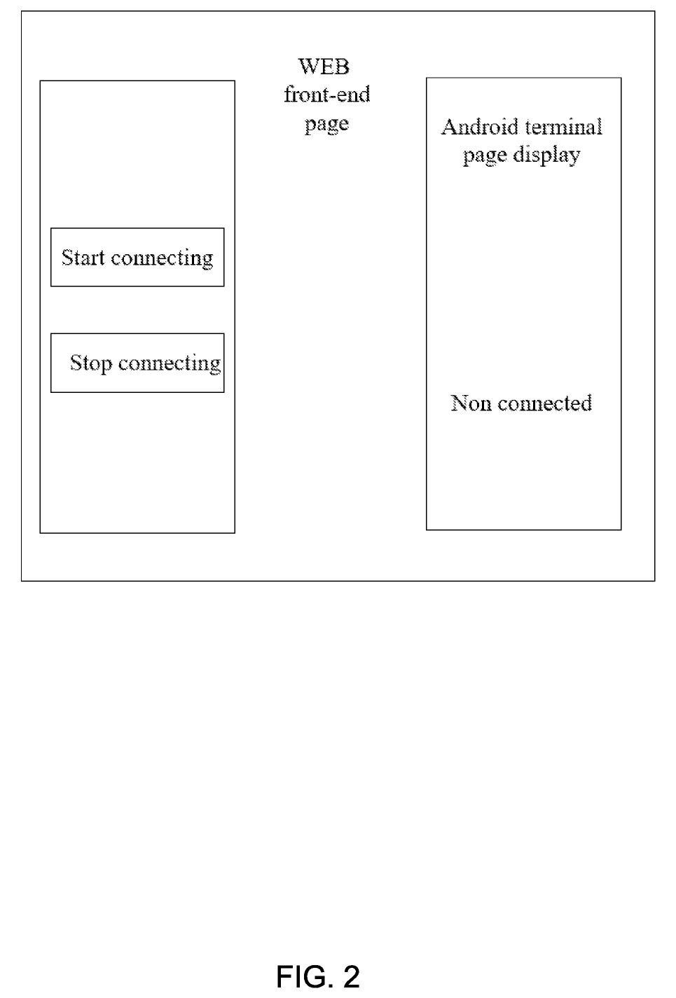

FIG. 3 is a first interface diagram of an android terminal provided by an embodiment of the present disclosure.

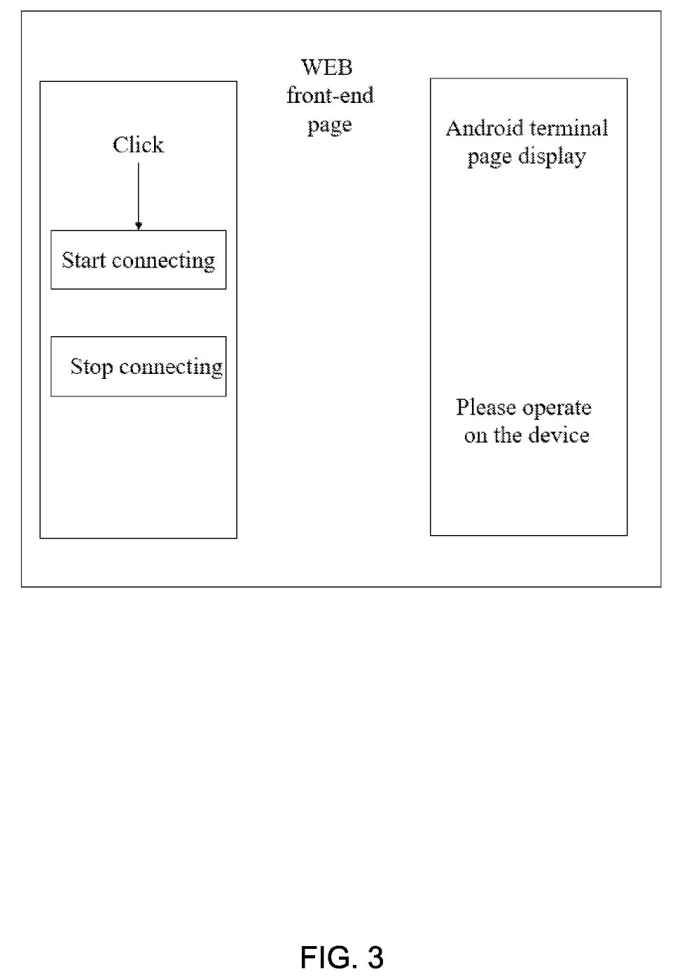

FIG. 4 is a second screen recording interface diagram of the web terminal provided in an embodiment of the present disclosure.

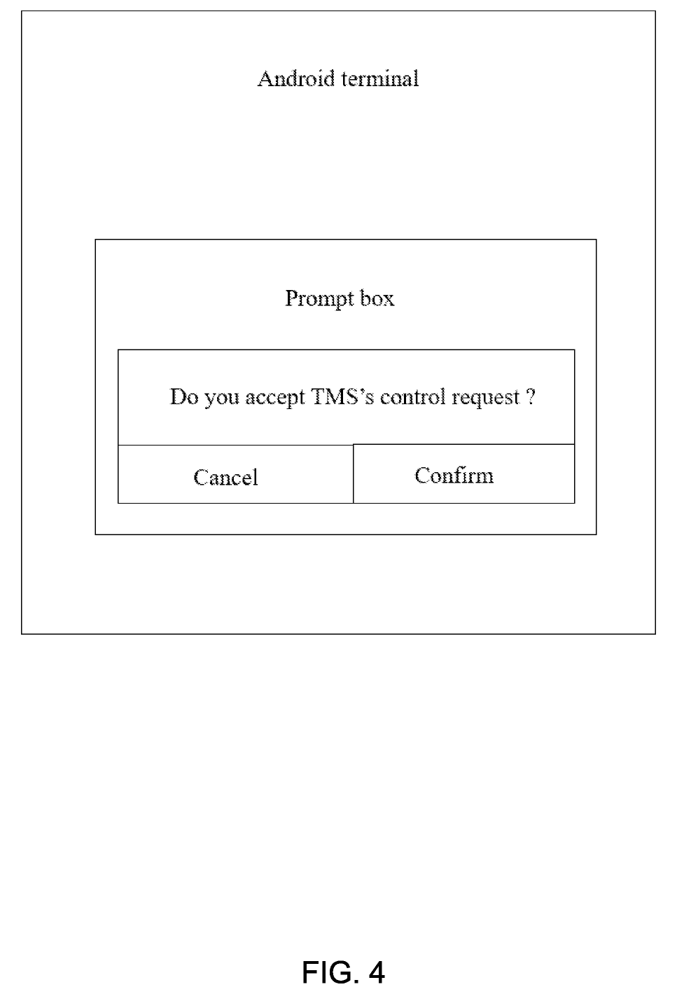

FIG. 5 is a second interface diagram of the android terminal provided by an embodiment of the present disclosure.

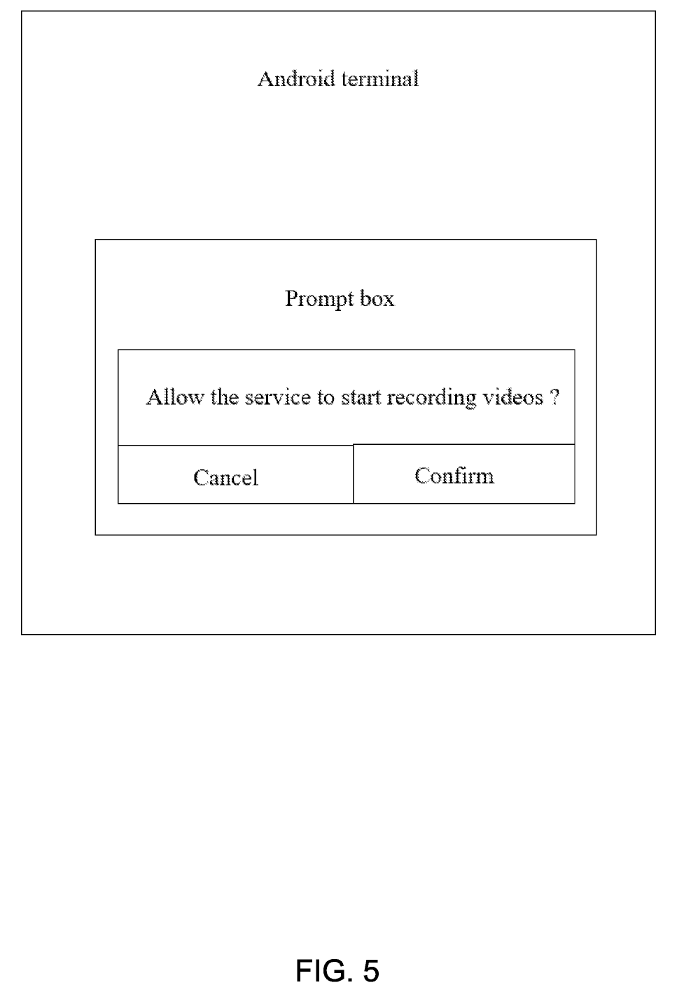

FIG. 6 is a third screen recording interface diagram of the web terminal provided in an embodiment of the present disclosure.

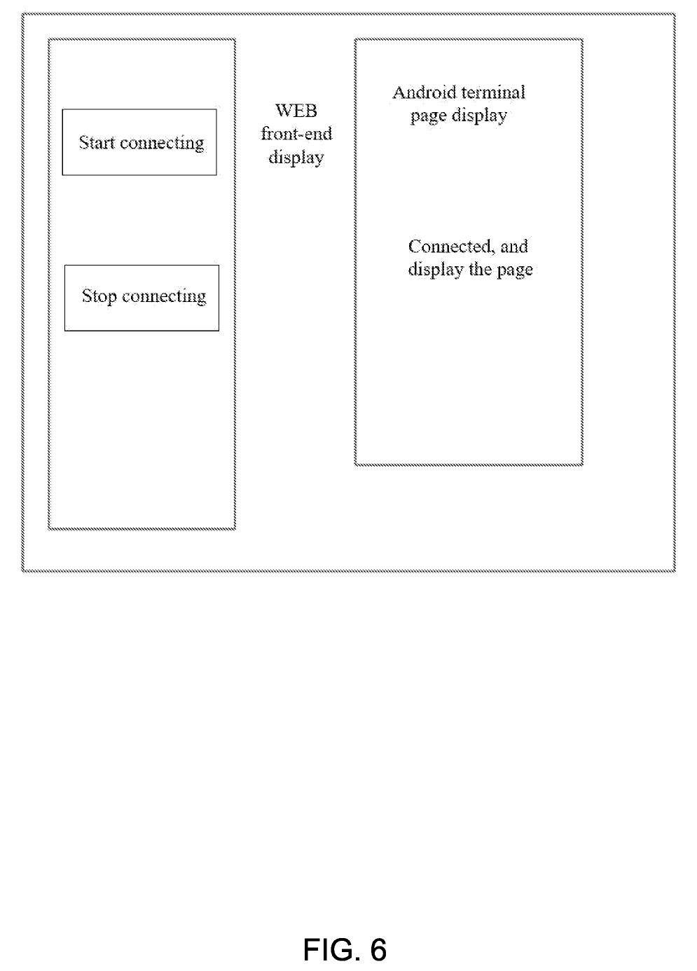

### DESCRIPTION OF EMBODIMENTS

Here, exemplary embodiments will be described in detail, with examples shown in the accompanying drawings. When referring to the accompanying drawings, unless otherwise indicated, the same numbers in different drawings represent the same or similar elements. The embodiments described in the following exemplary embodiments do not represent all embodiments consistent with the present application. On the contrary, they are only examples of devices and methods consistent with some aspects of the present application as described in the accompanying claims.

Firstly, clear definitions and explanations of terms involved in the present disclosure are provided.

MQTT control request: a request sent by a web front-end to establish control over an android terminal, communicated through a MQTT protocol.

Android terminal: a device that runs an android operating system and has ability to receive and execute a control instruction from an SRS server.

SP security chip: a security chip embedded in the android terminal, configured for generating a random number, storing a key, and other secure operations.

32-bit random number: a random number string generated by the SP security chip to ensure communication security, with a length of 32 bits.

SRS server: a server that provides services, responsible for receiving the control request sent by the web front-end, forwarding an instruction to the android terminal, and saving and verifying the random number.

WebRTC: a technology that supports real-time audio and video communication between web browsers, through which the web front-end obtains and displays screen recording information of the android terminal.

Opcode: an instruction code generated by the web front-end based on page operations, representing specific control actions, sent to the SRS server and executed by the android terminal.

Token: in the present disclosure, it refers to the random number stored by the SRS server as a verification identifier for this MQTT control request.

RSA Public Key: a public key part of an asymmetric encryption algorithm used to encrypt data and ensure the security of data transmission. In this specification, the public key is provided by the SP security chip.

Instruction protocol: a communication protocol defined between the android terminal and the SRS server, configured to specify format and parsing method of the instruction.

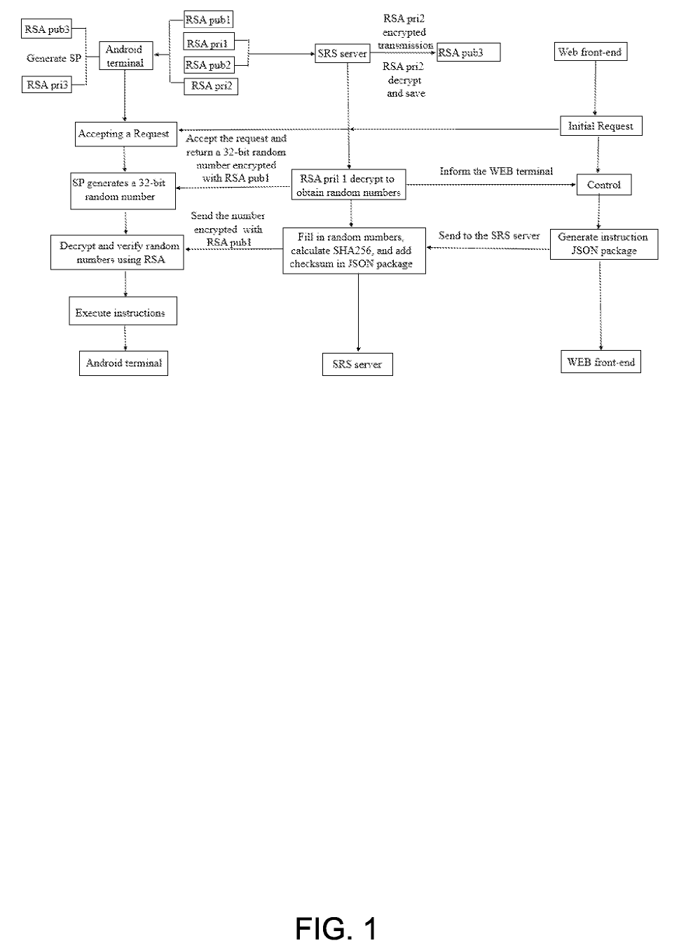

FIG. 1 is a flowchart of a secure two-party authentication method provided in an embodiment of the present disclosure; as shown in FIG. 1, an embodiment of the present disclosure provides a secure two-way authentication method, including:

a web front-end sends a control request to the SRS server through the MQTT protocol, requests an establishment of control over the android terminal; when the android terminal receives the control request for a first time, it generates a key pair containing a public key and a private key, and securely sends the public key to an SRS backend server after encryption; after receiving the control request for a second time, the android terminal agrees to the request through some means (such as user confirmation).

An SP security chip of the android terminal generates a pair of public and private keys, and generates a 32-bit random number for each control, and sends a result of agreeing to the control request (with the random number) to the SRS server.

The SRS server saves the 32-bit random number as the token for this control and waits for a further opcode.

The web front-end obtains and displays screen recording information of the android terminal through WebRTC technology, generates the opcode based on page operations, and sends the opcode to the SRS server.

The SRS server fills in the previously saved 32-bit random number after receiving the opcode, encrypts the random number using the RSA public key provided by the SP security chip, and then sends encrypted data and opcode together to the android terminal.

The android terminal uses the private key in the SP security chip to decrypt received data, verify whether the 32-bit random number is matched, and if it matches, execute the opcode.

In an implementation mode, the present disclosure realizes secure remote desktop control between the SRS server (a merchant management system) and the android terminal. Both have built-in RSA public and private keys (RSA1 public and private key pairs for the SRS server and RSA2 public and private key pairs for the android terminal), and introduce a set of RSA3 public and private key pairs automatically generated by the SP security chip of the android terminal.

A user initiates the control request for a specific android terminal through a Start button of a Remote Desktop function on the SRS server. When the android terminal receives MQTT message push for the first time, it will automatically generate the RSA3 public and private key pair through the SP security chip, encrypt the RSA3 public key using the RSA2 private key, and then send the encrypted RSA3 public key to the SRS server through an interface. The SRS server decrypts the received data using the RSA2 public key to obtain the RSA3 public key. After the user confirms a connection request on the SRS server (such as clicking yes through a pop-up box), the android terminal will generate a 32-bit random number again using the SP security chip, encrypt this random number using the RSA1 public key, and then send the encrypted random number to the SRS server. The SRS server uses RSA1 private key to decrypt and save this random number as the verification token for this control session.

After a successful connection, the android terminal will request a screen recording related permission. After the user clicks the “START NOW” button, the screen recording interface of the terminal will be transmitted in real-time to the corresponding front-end interface of the SRS server through WebRTC technology for the user to view and operate.

On the front-end interface, a user operation will generate corresponding operation instruction code, and the operation instruction code is passed to the SRS server. After receiving the operation instruction code, the SRS server will fill in the previously saved 32-bit random number, encrypt the instruction code and random number using the RSA3 public key, and then send encrypted data packet to the android terminal. The android terminal uses the RSA3 private key in the SP security chip to decrypt the received data packet and verify whether the 32-bit random number is correct. If the verification is successful, the terminal will execute an operation in the instruction code.

In this way, the present disclosure ensures the security and integrity of data transmission during remote desktop control.

On the other hand, the present application further provides a secure two-way authentication system, including:

a web front-end, an SRS server, and an android terminal, where the android terminal is provided with an SP security chip;

a web front-end, configured to send a control request to the SRS server through a MQTT protocol, requests an establishment of control over the android terminal;

an android terminal, configured to generate a key pair containing a public key and a private key when receiving the control request for a first time, and securely send the public key to an SRS backend server after encryption;

the android terminal, further configured for a user to agree to the control request through confirmation after receiving them for a second time;

an SP security chip of the android terminal generates a pair of public and private keys, and generates a 32-bit random number for each control; when agreeing to the control request, this random number is sent as a part of the result to the SRS server;

an SRS server, configured to store the 32-bit random number as a token for this control and wait for a further opcode;

a Web front-end, configured to obtain and display screen recording information of the android terminal through WebRTC technology, generate an opcode based on page operations, and send the opcode to the SRS server;

an SRS server, configured to fill previously saved 32-bit random number after receiving the opcode, encrypt the random number using the RSA public key provided by the SP security chip, and then send the encrypted data and opcode together to the android terminal;

the android terminal, configured to decrypt received data using the private key in the SP security chip, verify whether the 32-bit random number is matched, and execute the opcode if it is matched.

The secure two-way authentication method and system provided in this application achieves the protection of data transmission integrity and security by using two sets of built-in RSA public and private keys and one set of RSA public and private keys generated by the SP security chip for encryption and decryption.

At a first connection, this method uses two sets of built-in RSA public and private keys to encrypt and transmit the RSA public key generated by the SP security chip. Subsequently, the web front-end initiates the control request, and the android terminal agrees to the MQTT control request upon receiving it. The SP security chip generates the 32-bit random number and sends it as part of the request result to the backend, this 32-bit random number is saved in the backend as the token for this control.

At the same time, the web front-end obtains the screen recording information of the android terminal through WebRTC technology and displays it on the page. The user performs operations on the page, generates the corresponding opcodes, and then sends the opcode to the backend. After receiving the opcode, the backend fills in the previously saved 32-bit random number, encrypts the opcode and random number using the RSA public key of the SP security chip, and then sends the encrypted data to the android terminal.

After receiving encrypted data, the android terminal decrypts it using the private key in the SP security chip and verifies whether the 32-bit random number in the decrypted data matches the previously sent one. Only when the random number is matched, the android terminal will execute the corresponding opcode.

In this way, the method provided by the present disclosure ensures data transmission security during remote desktop control of the android device, effectively preventing a risk of data theft or tampering.

It should be understood that the present application is not limited to the precise structure described above and shown in the accompanying drawings, and various modifications and changes can be made without departing from its scope. The scope of this application is limited only by the appended claims.

What is claimed is:

1. A secure two-way authentication method, comprising:
sending a control request to a Simple Realtime Server, (SRS) server through a Message Queuing Telemetry Transport, (MQTT) protocol, by a web front-end, requesting an establishment of control over an android terminal;
when the android terminal receives the control request for a first time, automatically generating an Rivest-Shamir-Adleman, (RSA)3 public-private key pair, by a Security Chip, (SP) security chip of the android terminal, encrypting the RSA3 public key using the RSA2 private key, and sending it to the SRS server; wherein the android terminal is provided with the SP security chip, RSA2 public key, and RSA2 private key;
decrypting the RSA3 public key data encrypted by the android terminal using the RSA2 private key through the RSA2 public key, by the SRS server, obtaining the RSA3 public key, and waiting for a user to confirm a connection request; the SRS server comprises a built-in RSA1 private key and RSA1 public key;
after the user confirming the request, generating a 32-bit random number, by the SP security chip of the android terminal, encrypting the 32-bit random number using the RSA1 public key of the SRS server, and sending it to the SRS server;
decrypting and saving the 32-bit random number as a verification token using the RSA1 private key, by the SRS server;
obtaining a screen recording permission, by the android terminal, and transmitting a screen recording interface in real-time to the web front-end of the SRS server through Web Real-Time Communications, (WebRTC) technology;
generating an operation instruction code, by the web front-end, and sending it to the SRS server; filling in the 32-bit random number, by the SRS server, and encrypting the operation instruction code and the 32-bit random number using the RSA3 public key; sending encrypted data packet to the android terminal;
decrypting received data packet using the RSA3 private key in the SP security chip, by the android terminal, and verifying whether the 32-bit random number is correct; when the verification passes, executing an operation in the operation instruction code, by the android terminal.

2. A system for remote desktop control of an android device based on security control, comprising:
a web front-end, an SRS server, and an android terminal, wherein the android terminal is provided with an SP security chip, an RSA2 public key, and a RSA2 private key; the SRS server comprises a built-in RSA1 private key and a RSA1 public key;
the web front-end sends a control request to the SRS server through a MQTT protocol, requests an establishment of control over the android terminal;
when the android terminal receives the control request for a first time, the SP security chip automatically generates an RSA3 public-private key pair, encrypts the RSA3 public key using the RSA2 private key, and sends it to the SRS server;
the SRS server decrypts the RSA3 public key data encrypted by the Android terminal using the RSA2 private key through the RSA2 public key, obtains the RSA3 public key, and waits for a user to confirm a connection request;
after the user confirms the request, the SP security chip of the Android terminal generates a 32-bit random number, encrypts the 32-bit random number using the RSA1 public key of the SRS server, and sends it to the SRS server;
the SRS server decrypts and saves the 32-bit random number as a verification token using the RSA1 private key;
the android terminal obtains a screen recording permission and transmits a screen recording interface in real-time to the web front-end of SRS server through WebRTC technology;
the web front-end generates an operation instruction code and sends it to the SRS server; the SRS server fills in the 32-bit random number and encrypts the operation instruction code and the 32-bit random number using the RSA3 public key; encrypted data packet is then sent to the android terminal;
the android terminal decrypts received data packet using the RSA3 private key in the SP security chip, and verifies whether the 32-bit random number is correct; when the verification passes, the android terminal executes an operation in the operation instruction code.
